(19) United States
(12) Patent Application Publication
(10) Pub. No.: US 2007/0260360 A1
(43) Pub. Date: Nov. 8, 2007

(54) On-Board Vehicle Terminal and Associated Logistics Management System

(75) Inventors: Christian Laschke, Berlin (DE); Tomislav Zivkovic, Kleinmachnow (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler, Stuttgart (DE)

(21) Appl. No.: 10/581,886

(22) PCT Filed: Nov. 10, 2004
(86) PCT No.: PCT/EP04/12689

§ 371 Date: Jun. 1, 2007

(30) Foreign Application Priority Data
Dec. 6, 2003 (DE) 103 57 122.1

(51) Int. Cl. G06F 17/00; B41J 2/00; G06F 3/041; G06Q 10/00; G06K 7/10; G01C 21/34

(52) U.S. Cl. 701/1; 235/462.01; 345/173; 400/103; 701/200; 705/8

(57) ABSTRACT

A vehicle terminal for a logistics management system, having a display unit (7), a vehicle computer (6) for detection and processing of relevant data, a communication unit (8) for data interchange with an associated disposition center (2), which transmits job data records to the vehicle terminal, with the vehicle terminal transmitting job-relevant data to the disposition center (2) after processing a job, and to an associated logistics management system. The vehicle computer (6) is designed to receive and to process job data records from at least one further center (3.1, 3.2) via the communication unit (8), which job data records each include data relating to a job location and a job booking, and to create a job list, in which case the job data records and the job list can be displayed to the driver via the display unit (7).

### BACKGROUND AND SUMMARY OF THE INVENTION

The invention relates to a vehicle terminal, that is to say to a system part in a vehicle, for a logistics management system and to an associated logistics management system.

Modern transport vehicles are increasingly making use of logistics management systems in conjunction with an associated disposition center for planning and control of transport jobs and vehicle usage, as well as for tour planning, for job-oriented navigation and for routing of individual vehicles. Furthermore, the logistics management system can locate vehicles associated with the disposition center, and can display their location on a map.

The applicant is offering the “Fleetboard” service for this purpose at the Internet address http://www.fleetboard.com, under the keyword “Flottenmanagement mit IQ” [Fleet management with IQ]. The Fleetboard service allows communication between a disposition center and at least one vehicle, in which case preferably logistics data can be transmitted in both directions. The disposition center which is involved in this logistics management system can thus transfer jobs automatically from a job recording system, can share them between the individual vehicles and tours involved, and can plan the vehicle tours. The position of each vehicle can be determined and be displayed on a map. The evaluation of the tours and of the recorded vehicle data assists the management of the vehicles and makes it easier to associate costs with jobs. As a system part in the vehicle, the vehicle terminal include a vehicle computer, a keyboard and a screen display as well as GSM telephone for communication between the vehicle and the associated disposition center.

Logistics management systems for commercial vehicles, which include the vehicle as a mobile equipment part in the operational data and communication organization, are described in the article by H. -D. Chemnitz: “Informations-und Kommunikationssysteme im Nutzfahrzeug”, [Information and Communication Systems in commercial vehicles], VDI Reports 687 (1988), pages 461 to 480. Modules for driver information, for manual data recording, for copy printing and for recording of journey data and vehicle data are provided in the vehicle. A portable hand-held terminal is used for data recording and as a visual display unit for the driver. A vehicle pool system produces tour plans and analyses of tours, of the vehicle pool, of the vehicles, of the personnel and of the costs. The vehicle pool system and the associated vehicle system are connected to one another by radio, for example.

One object of the invention is to provide a vehicle terminal for a logistics management system which is matched particularly well to the requirements for distribution and delivery traffic and which makes it easier to distribute and deliver goods, and to specify an associated logistics management system.

The invention is based on the concept that a vehicle terminal for a logistics management system receives not only job data records from its associated disposition center but also from other centers which can transmit corresponding job data records via a communication system to the vehicle. A vehicle computer, which is associated with the vehicle terminal, receives the job data records via the communication system, in each case including data relating to a job location and a job booking, and processes this data. The vehicle computer then creates a job list, and displays the list to the driver via a display unit.

The vehicle terminal according to the invention makes it possible for the driver of a transport vehicle to convey goods, packages, letters etc. for various customers, who can act as further centers, and thus to make optimal use of his transport capacity.

In one advantageous refinement, the vehicle terminal has a navigation system which calculates a route on the basis of the created job list and guides the driver to the next job location.

In a further refinement, on receipt of a new job data record, the vehicle computer checks, by comparison with the existing job list, whether the new job can be handled, and displays the check result to the driver via the display unit.

In one advantageous development of the vehicle terminal, once the driver has accepted the new job, the vehicle computer updates the job list and displays the updated job list to the driver.

In a further refinement, once the job has been accepted, the navigation system calculates a new route taking into account the previous job locations and job bookings, and guides the driver to the next job location on the basis of the updated route.

The described inclusion of new jobs in the existing job list gives the vehicle terminal the capability for the vehicle to be able to react flexibly to new jobs and to optimally utilize its transport capacity.

In one particular advantageous development of the vehicle terminal, after reaching one of the job locations, and in order to carry out the job, the vehicle computer transmits the associated job data via an appropriate interface to a portable hand-held terminal, which transmits job-relevant data to the vehicle computer once the job has been carried out.

In a further refinement, the hand-held terminal can be inserted into a holder which includes the interface for data interchange between the hand-held terminal and the vehicle computer.

The portable hand-held terminal preferably has a barcode reader for reading data for carrying out the job.

The hand-held terminal designed in this way makes it possible for the driver to easily and quickly transfer coded data from a barcode medium and to transmit the data that has been read to the vehicle computer for further processing, in particular in order to create delivery and cost information.

In addition, the vehicle apparatus may have a barcode printer for printing coded job-relevant data onto a barcode medium.

In one advantageous embodiment of the vehicle terminal, once the job has been carried out, the vehicle computer associates the job-relevant data with the center that places the job, and transmits this data, for example, to the associated disposition center for invoice production. The transmission of the data to the associated disposition center allows the latter to produce an invoice for costs incurred as well as an analysis and documentation of the service components used, such as the driving time, waiting time and service provided at the customer's premises.

In a further refinement, the display unit has a screen and/or a speech output unit.

In one advantageous refinement of the invention, the screen and the input unit are in the form of a touchscreen.

For good control and display convenience, the screen has a plurality of display areas in order to display a menu structure, at least one of which is displayed permanently over all of the menu levels, and of which at least one display area displays information associated with a selected menu level, as a function of the selected menu level.

In a first menu level, the screen includes, for example, a main menu strip, a configuration area for system settings and a system area for system registration.

In a second menu level, the screen displays, for example, information from the navigation system for routing, or the job list, or detailed information relating to a job.

Alternatively or additionally, the job list or a job that is to be carried out at that time can be read in advance by the speech output system to the driver.

A logistics management system according to the invention includes at least one vehicle with the vehicle terminal according to the invention.

### BRIEF DESCRIPTION OF THE DRAWINGS

Advantageous embodiments of the invention will be described in the following text and are illustrated in the drawings, in which:

FIG. 1 shows a block diagram of a logistics management system;

FIG. 2 shows a block diagram of a vehicle terminal for the logistics management system shown in FIG. 1;

FIG. 3 shows a schematic illustration of a screen display for the vehicle terminal shown in FIG. 2, in a first menu level;

FIG. 4 shows a schematic illustration of a screen display in a second menu level;

FIG. 5 shows a schematic illustration of a screen display in a third menu level; and

FIG. 6 shows a schematic illustration of a screen display and of a hand-held terminal for the vehicle terminal.

### DETAILED DESCRIPTION OF THE DRAWINGS

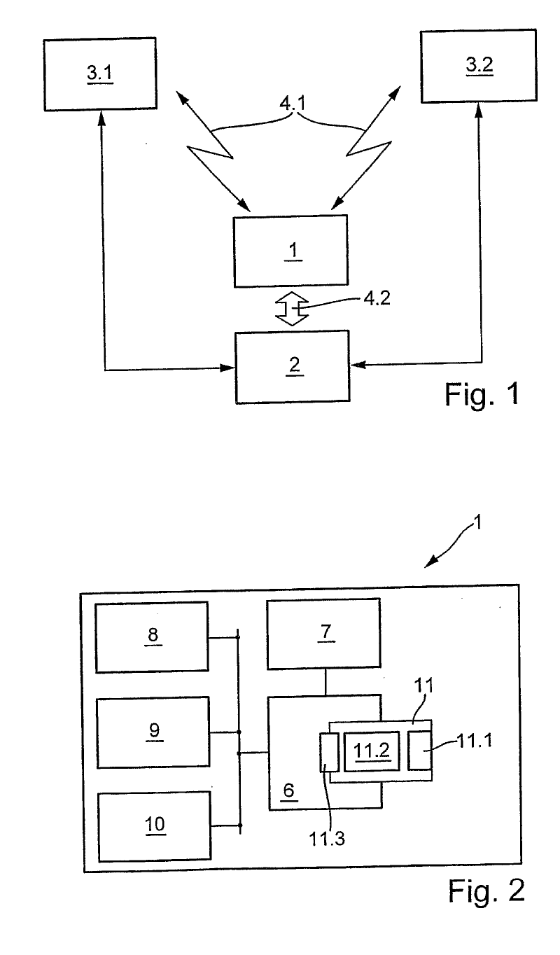

The logistics management system according to the invention shown in FIG. 1 comprises one or more vehicles, one vehicle 1 of which is shown in a representative form in FIG. 1, a disposition center 2 and one or more further centers, in the example in FIG. 1 two further centers 3.1, 3.2 which, for example, each represent one additional potential customer. The at least one vehicle 1 and the associated disposition center 2 interchange data via a communication link 4.2 which, for example, is in the form of a GSM link. For example, the disposition center 2 transmits, in particular, job data records to the vehicle 1, which are then acted upon.

The respective further center 3.1, 3.2 has a communication system, which is not illustrated, for data interchange with the respective vehicle 1 by corresponding communication links 4.1, which may likewise be in the form of GSM links. The further centers 3.1, 3.2 can also send job data records to the at least one vehicle 1 via the communication links 4.1. After receiving a further job data record such as this, the vehicle 1 checks whether the received job can or cannot be carried out by it. After this check, the vehicle 1 informs the customer via one of the communication links 4.1 whether the job can or cannot be actioned by it.

FIG. 2 shows a vehicle terminal for the logistics management system shown in FIG. 1. In the illustrated exemplary embodiment, the vehicle terminal includes a combined input and output unit 7 which, for example, is in the form of a touchscreen, a vehicle computer 6 for holding a portable hand-held terminal 11, a communication unit 8 for data interchange with the associated disposition center 2, and the further potential customers 3.1, 3.2, a navigation system 9 and a printer 10 for the barcode medium. The portable hand-held terminal 11 includes a barcode scanner 11.1, an input and/or output unit 11.2 and an interface 11.3 for data interchange with the vehicle computer 6. The method of operation of the individual components in the logistics management system will be described in the following text with reference to FIGS. 1 to 6.

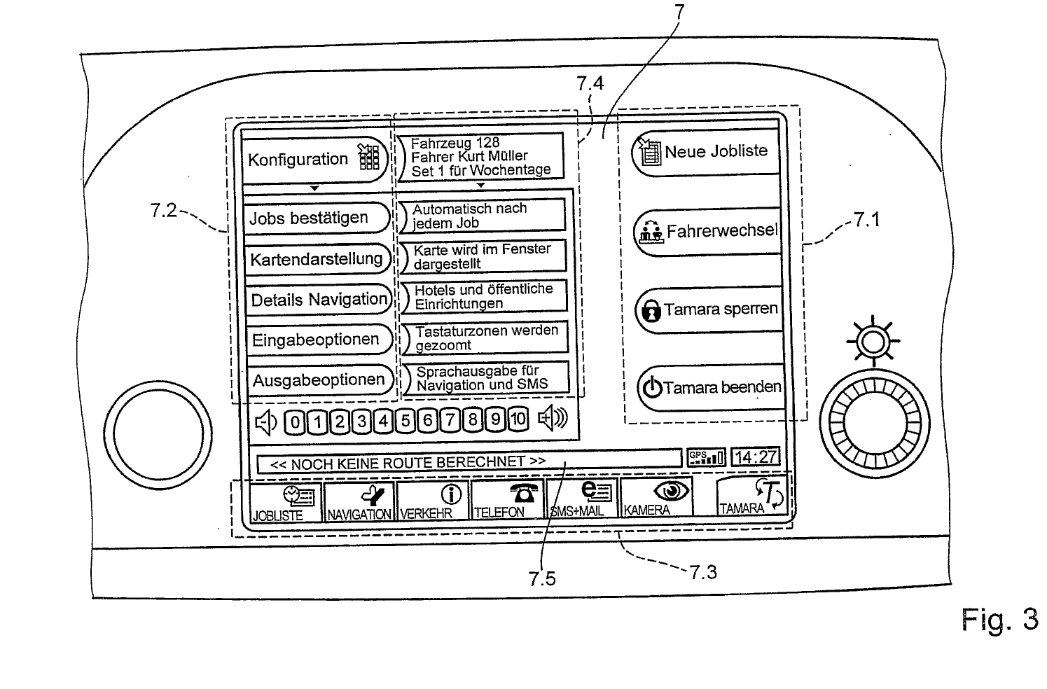

The vehicle terminal in the vehicle 1 uses the communication unit 8 to receive job data records via the communication links 4.1 and 4.2 from the associated disposition center 2 and from the centers 3.1, 3.2 of the other customers. Once the vehicle terminal has been switched on, the touchscreen 7 displays to the driver a first menu level of a menu structure, which is illustrated in FIG. 3.

The display on the touchscreen 7 comprises a plurality of display areas 7.1, 7.2, 7.3, which are designed as touch-sensitive buttons, in order to select displayed functions. Further display areas 7.4 and 7.5 are used to display information about functions to be carried out or selected parameters. The display area 7.3 is in the form of a main menu strip, and is displayed permanently over all menu levels. The display areas 7.1, 7.2, 7.4 and 7.5 have varying contents depending on the menu level activated and, for example, display information associated with the selected menu level.

The display area 7.1 displays a system area, in which the driver is guided, registered and logged-off by appropriate operation of the associated buttons in the logistics management system, in the illustrated example entitled “Tamara”. This comprises in particular the processes of registering with and logging-off from the disposition center 2 and one or more of the other centers 3.1, 3.2. The display area 7.2 shows a configuration area, in which the driver can change system settings by appropriate operation of the associated buttons. The current system settings and information relating to the current system settings are displayed in the display area 7.4.

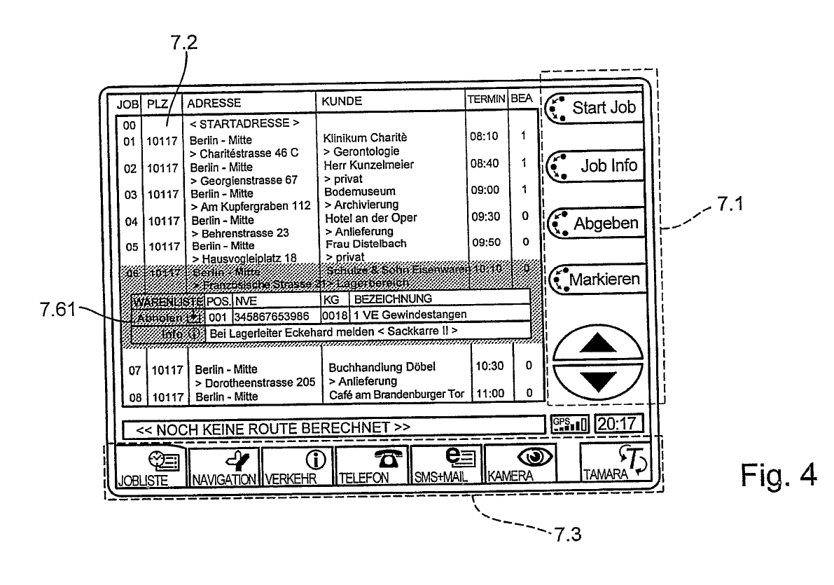

By operation of a “job list” button in the main menu strip 7.3, the vehicle computer 6 calculates a current job list 7.6 from the job data records so far received via the communication unit 8 from the disposition center 2 or from the other customers 3.1, 3.2, and displays this list to the driver in a second menu level on the touchscreen 7. This second menu level is illustrated in FIG. 4. The display area 7.1 and the associated buttons are used to process the job list 7.6 in this second menu level.

In a further display area 7.61, detailed information relating to the selected or marked job is displayed within the current job list 7.6, in the illustrated example relating to a job whose number is 06.

A job data record in each case includes data relating to a job location (address) and a job booking (schedule), and the job data record may also include further detailed information, such as the name of the customer and the nature of the job, for example whether goods are intended to be picked up or delivered, whether any additional aids are required such as a trolley for sacks or a fork-lift truck in order to carry out the job, or who the contact is at the job location.

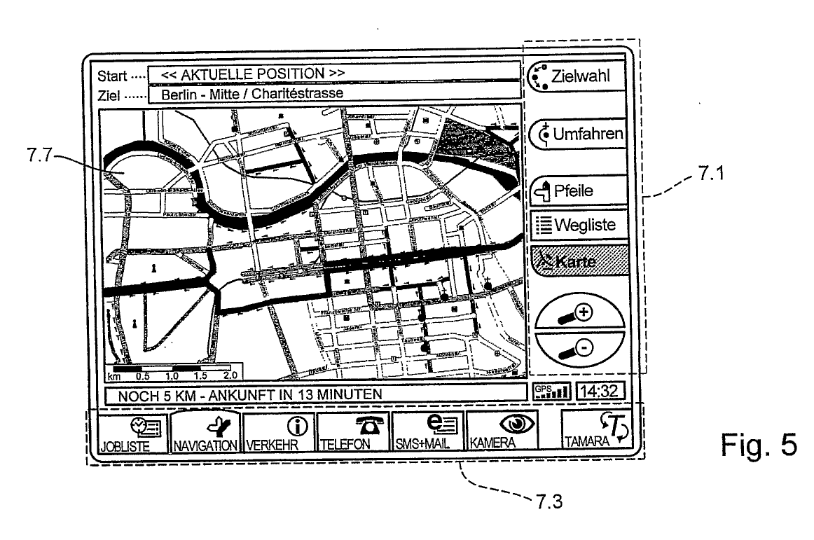

The navigation system 9 uses the job list created by the vehicle computer 6 to calculate a route, and guides the driver to the next job location. Alternatively, it is possible for the route to be calculated in the disposition center 2 associated with the vehicle 1, and then to be transmitted to the vehicle terminal. For route calculation, the vehicle terminal in this case transmits the created job list to the disposition center 2. The calculated route is displayed to the driver after operation of a “navigation” button in the main menu strip 7.3 in a third menu level, which is illustrated in FIG. 5, for example as a map display 7.7. In the illustrated third menu level, the display area 7.1 is used with the associated buttons for control of the navigation system 9.

If the communication unit 8 receives a new job data record during operation of the logistics management system, then the vehicle computer 6 compares this with the existing job list 7.6 to determine whether the new job can be carried out, and displays the result of the check to the driver via the touchscreen 7. After confirmation by the vehicle computer 6 whether the job can be carried out, the driver or the vehicle computer transmits an appropriate message to the customer, that is to say to the disposition center 2 or to one of the other customers 3.1, 3.2, stating whether the job has been accepted or rejected.

Once the job has been accepted by the driver, the vehicle computer 6 updates the job list 7.6 by including the new job, and displays the updated job list to the driver. The acceptance of the job and the updating of the job list can be activated by the driver, for example by operation of the “new job list” button in the display area 7.1 in the first menu level.

After acceptance of the job, the navigation system 9 calculates a new route taking into account the previous job locations and job bookings, and guides the driver to the next job location on the basis of the updated route.

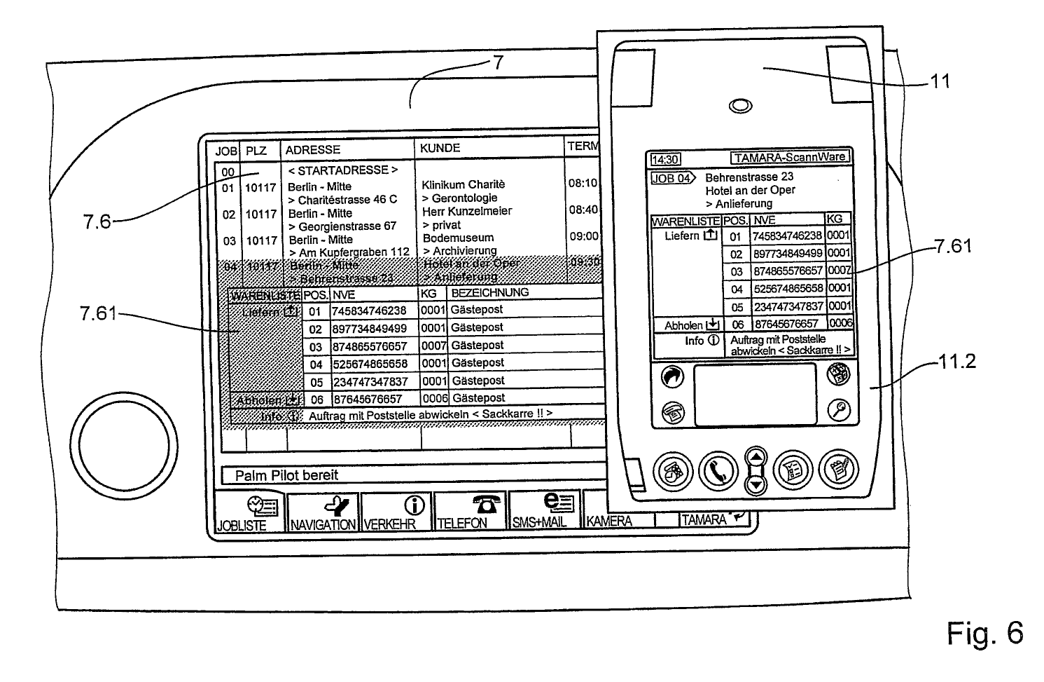

After reaching one of the job locations, and in order to carry out the job, the vehicle computer 6 transmits the associated job data via the interface 11.3 to the portable hand-held terminal 11 which transmits job-relevant data to the vehicle computer 6 once the job has been carried out. This process is illustrated by FIG. 6. The touchscreen 7 in FIG. 6 shows the job list and the job data record associated with the current job location, in the display area 7.61. As can also be seen from FIG. 6, the output unit 11.2 of the portable hand-held terminal 11 displays the same job data record, since the corresponding job-relevant data has been transmitted from the vehicle computer 6 via the interface 11.3 to the portable hand-held terminal 11.

During the journey, the hand-held terminal 11 may, for example, be inserted into a holder, which forms the interface 11.3 for data interchange between the hand-held terminal 11 and the vehicle computer 6. However, it is also possible for the interface to transmit data over a greater range, for example by means of radio, so that the hand-held terminal 11 need not be inserted into the holder in order to transmit data.

In order to receive job-relevant data for goods to be picked up or to be delivered, the portable hand-held terminal 11 in the illustrated exemplary embodiment has a barcode reader 11.1 for reading data for carrying out the job.

In order to identify goods, the vehicle terminal in the illustrated exemplary embodiment has a barcode printer 10, by means of which coded job-relevant data can be printed onto a barcode medium.

Once the job has been carried out, the vehicle computer 6 associates the job-relevant data with the customer, that is to say the disposition center 2 or one of the other customers 3.1, 3.2, and transmits job-relevant data, such as delivery and/or invoicing data, via the communication unit 8 for invoice production to the disposition center 2. The invoice for carrying out the job is then transmitted from the disposition center to the other customer 3.1 or 3.2.

The input and output unit which is illustrated in FIG. 2 also has a speech input and speech output unit for easy operation of the vehicle terminal. For example, the job list can be read aloud to the driver, thus distracting him less from the traffic.

The vehicle terminal according to the invention and the associated logistics management system allow the driver to carry out not only job data records from his associated disposition center but also from other centers which transmit appropriate job data records via a communication system to the vehicle. This makes it possible for the driver of a transport vehicle to accept jobs directly from the various customers, and to convey goods, packages, letters, etc., and thus to make optimum use of his transport capacity.

Furthermore, the described inclusion of new jobs in the existing job list makes it possible for the driver to react flexibly to new jobs, and to optimize his transport capacity. The vehicle terminal according to the invention and the associated logistics management system are thus very well matched to the requirements of distribution and delivery traffic, thus making it easier to distribute and deliver goods.

1-16. (canceled)

17. A vehicle terminal for a logistics management system, said terminal comprising:
a display unit,
a vehicle computer for detection and processing of relevant data,
a communication unit for data interchange with an associated disposition center, wherein said communication unit transmits job data records to the vehicle terminal, with the vehicle terminal transmitting vehicle-relevant data to the disposition center after processing a job, wherein
the vehicle computer receives and processes job data records from at least one further center via the communication unit, which job data records each include data relating to a job location and a job booking, and said vehicle computer creates a job list, in which case the job data records and the job list are displayed to a driver via a display unit.

18. The vehicle terminal as claimed in claim 17, further comprising a navigation system which calculates a route on the basis of the created job list and guides the driver to the next job location.

19. The vehicle terminal as claimed in claim 17, wherein,
on receipt of a new job data record, the vehicle computer checks by comparison with the job list whether the new job can be handled, and displays the check result to the driver via the display unit.

20. The vehicle terminal as claimed in claim 19, wherein
once the driver has accepted the job, the vehicle computer updates the job list by inclusion of the new job, and displays the updated job list to the driver.

21. The vehicle terminal as claimed in claim 20, wherein,
once the job has been accepted, a navigation system calculates a new route taking into account the previous job locations and job bookings, and guides the driver to the next job location on the basis of the updated route.

22. The vehicle terminal as claimed in claim 18, wherein
after reaching one of the job locations, and in order to carry out the job, the vehicle computer transmits the associated job data via an appropriate interface to a portable hand-held terminal, which transmits job-relevant data to the vehicle computer once the job has been carried out.

23. The vehicle terminal as claimed in claim 22, wherein
the hand-held terminal is inserted into a holder which includes the interface for data interchange between the hand-held terminal and the vehicle computer.

24. The vehicle terminal as claimed in claim 22, wherein
the portable hand-held terminal has a barcode reader for reading data for carrying out the job.

25. The vehicle terminal as claimed in claim 22, further comprising:
a barcode printer for printing coded job-relevant data onto a barcode medium.

26. The vehicle terminal as claimed in claim 22, wherein
once the job has been carried out, the vehicle computer associates the job-relevant data with a center from said center and said at least one further center that places the job.

27. The vehicle terminal as claimed in claim 17, wherein
the display unit comprises at least one of a screen and a speech output unit.

28. The vehicle terminal as claimed in claim 27, wherein the screen and an input unit are integrated in a unit in the form of a touchscreen.

29. The vehicle terminal as claimed in claim 27, wherein
the screen has a plurality of display areas in order to display a menu structure, at least one of said display areas is displayed permanently over all of the menu levels, and at least another one of the display areas displays information associated with a selected menu level, as a function of the selected menu level.

30. The vehicle terminal as claimed in claim 29, wherein
in a first menu level, the screen comprises a main menu strip, a configuration area for system settings and a system area for system registration.

31. The vehicle terminal as claimed in claim 29, wherein
in a second menu level, the screen displays information from the navigation system for routing, or the job list, or detailed information relating to a job.

32. A logistics management system having
at least one vehicle and an associated disposition center,
the at least one vehicle includes a vehicle terminal as claimed in claim 17.

33. The vehicle terminal as claimed in claim 19, wherein
after reaching one of the job locations, and in order to carry out the job, the vehicle computer transmits the associated job data via an appropriate interface to a portable hand-held terminal, which transmits job-relevant data to the vehicle computer once the job has been carried out.

34. The vehicle terminal as claimed in claim 20, wherein
after reaching one of the job locations, and in order to carry out the job, the vehicle computer transmits the associated job data via an appropriate interface to a portable hand-held terminal, which transmits job-relevant data to the vehicle computer once the job has been carried out.

35. The vehicle terminal as claimed in claim 23, further comprising:
a barcode printer for printing coded job-relevant data onto a barcode medium.

36. The vehicle terminal as claimed in claim 23, wherein
once the job has been carried out, the vehicle computer associates the job-relevant data with a center from said center and said at least one further center that places the job.
